(19) United States
(12) Patent Application Publication
(10) Pub. No.: US 2024/0354507 A1
(43) Pub. Date: Oct. 24, 2024

(54) KEYWORD EXTRACTION METHOD, DEVICE, COMPUTER EQUIPMENT AND STORAGE MEDIUM

(71) Applicant: Shenzhen Donson Cloud Technology Co., Ltd., Shenzhen (CN)

(72) Inventors: Heyang Liu, Shenzhen (CN); Yue Lin, Shenzhen (CN); Pinyin Lu, Shenzhen (CN); Yunyang Li, Shenzhen (CN)

(21) Appl. No.: 18/533,226

(22) Filed: Dec. 8, 2023

(30) Foreign Application Priority Data
Apr. 20, 2023 (CN) 202310438906.0

(51) Int. Cl. G06F 40/289; G06F 40/253

(52) U.S. Cl. CPC G06F 40/289; G06F 40/253

(57) ABSTRACT

The application relates to the technical field of information extraction, in particular to a keyword extraction method. The method comprises: acquiring a text to be processed, and performing word segmentation on the text to be processed to obtain at least one word segmentation result; performing entity recognition on all the word segmentation results through a preset entity recognition model to obtain at least one entity recognition result; performing part-of-speech tagging on all the entity recognition results to obtain part-of-speech tagging results; scoring all the part-of-speech tagging results through a preset scoring metric to obtain score values; filtering all the part-of-speech tagging results based on all the score values to obtain at least one target word; running word co-occurrence statistics on all the target words to obtain word co-occurrence values, and performing keyword extraction on all the target words based on the word co-occurrence values to obtain keyword extraction results.

### CROSS REFERENCE TO RELATED APPLICATIONS

The present application claims the benefit of Chinese Patent Application No. 202310438906.0 filed on Apr. 20, 2023, the contents of which are incorporated herein by reference in their entirety.

### TECHNICAL FIELD

The application relates to the technical field of information extraction, in particular to a keyword extraction method, device, computer equipment and storage medium.

### BACKGROUND

With the development of science and technology, natural language processing technology has also developed rapidly. For example, phrase extraction technology, keyword extraction technology or entity recognition technology.

In the prior art, there are two methods for keyword extraction technology. One is to supervise the model based on labeled sample data to enhance the keyword extraction ability of the model. However, there is not a large number of labeled sample data in some application fields. The other method is unsupervised training of the model based on statistical methods, which relies on the results of text segmentation and lacks the use of text semantics. In addition, the unsupervised method mainly has the following two shortcomings: (1) Word segmentation accuracy: because the word segmenter in the prior art is trained based on the general corpus, but not the business language corpus, the word segmentation effect is not good for the data containing many business terms. (2) It is difficult to identify key phrases: most business data often contains many key phrases, which are usually consisted of two or three words. The existing keyword algorithms are generally aimed at word granularity, and it is difficult to identify keywords in the form of phrases. Consequently, the above methods can not accurately extract the keywords of particular terms from text, resulting in a low accuracy of keyword extraction.

### SUMMARY

In view of this, it is necessary to provide a keyword extraction method, device, computer equipment and storage medium to solve the problem of low accuracy of text segmentation in the prior art.

Provided is a keyword extraction method, including the following steps:
acquiring a text to be processed, and performing word segmentation on the text to be processed to obtain at least one word segmentation result;
performing entity recognition on all the word segmentation results through a preset entity recognition model to obtain at least one entity recognition result;
performing part-of-speech tagging on all the entity recognition results to obtain part-of-speech tagging results;
scoring all the part-of-speech tagging results through a preset scoring metric to obtain score values;
filtering all the part-of-speech tagging results based on all the score values to obtain at least one target word;
running word co-occurrence statistics on all the target words to obtain word co-occurrence values, and performing keyword extraction on all the target words based on the word co-occurrence values to obtain keyword extraction results.

Provided is a keyword extraction device, including:
word segmentation processing module, configured to acquire a text to be processed, and performing word segmentation on the text to be processed to obtain at least one word segmentation result;
an entity recognition module, configured to perform entity recognition on all the word segmentation results through a preset entity recognition model to obtain at least one entity recognition result;
a part-of-speech tagging module, configured to perform part-of-speech tagging on all the entity recognition results to obtain part-of-speech tagging results;
a feature scoring module, configured to score all the part-of-speech tagging results through a preset scoring metric to obtain score values;
a word filtering module, configured to filter all the part-of-speech tagging results based on all the score values to obtain at least one target word; and
a result extraction module, configured to run word co-occurrence statistics on all the target words to obtain word co-occurrence values, and perform keyword extraction on all the target words based on the word co-occurrence values to obtain keyword extraction results.

Provided is a computer equipment, including a memory, a processor and computer-readable instructions stored in the memory and executable by the processor, when the processor executes the computer-readable instructions, the keyword extraction method described above is realized.

Provided are one or more readable storage media, storing computer-readable instructions, when the computer-readable instructions are executed by one or more processors, the keyword extraction method described above is implemented.

According to the above keyword extraction method, device, computer equipment and storage medium, the entity recognition is performed on all the word segmentation results corresponding to the text to be processed through a preset entity recognition model, thereby realizing entity recognition on the word segmentation results individually, and further realizing the acquisition of the entity recognition results. By performing part-of-speech tagging on and scoring all the entity recognition results, the determination of the tagging results and the acquisition of the score values are realized. By filtering all the part-of-speech tagging results based on all the score values, the noise words are filtered out, and thus the target words are obtained. By running word co-occurrence statistics on all the target words, the computation of word co-occurrence values and the extraction of keywords are realized, and then the extraction of key phrases is realized, which improves the accuracy of keyword extraction.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a schematic diagram of an application environment of a keyword extraction method according to an embodiment of the present application.

FIG. 2 is a flowchart of a keyword extraction method according to an embodiment of the present application.

FIG. 3 is a structural schematic diagram of a keyword extraction device according to an embodiment of the present application.

FIG. 4 is a schematic diagram of a computer equipment according to an embodiment of the present application.

### DETAILED DESCRIPTION OF PREFERRED EMBODIMENTS

The technical solutions in the embodiments of the present application will be clearly and completely described below with reference to the drawings in the embodiments of this application. Obviously, the described embodiments are part of the embodiments of this application, but not all of them. Based on the embodiments in this application, all other embodiments obtained by those of ordinary skill in the art without creative effort belong to the protection scope of this application.

The keyword extraction method provided by this embodiment may be applied in the application environment shown in FIG. 1, in which the client communicates with the server. The client may include but is not limited to various personal computers, notebook computers, smart phones, tablet computers and portable wearable devices. The server may be an independent server or a server cluster composed of multiple servers.

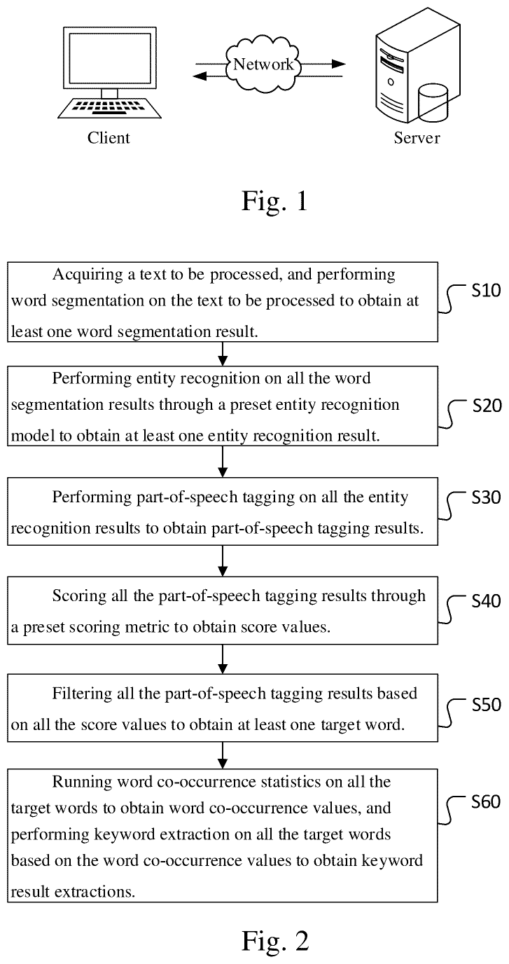

In an embodiment, as shown in FIG. 2, a keyword extraction method is provided, and the application of this method in the server in FIG. 1 is taken as an example for illustration, including the following steps:

S10: acquiring a text to be processed, and performing word segmentation on the text to be processed to obtain at least one word segmentation result.

Specifically, the text to be processed may be collected from different databases, or collected from different websites through crawler technology, or uploaded from the client to the server, i. e., at least one text to be processed may be obtained. Then, all the texts to be processed are segmented. That is, performing full segmentation path selection on the text to be processed according to the connection of contextual characteristics, i. e., all possible segmentation results are listed, the best segmentation path would be selected, and all the segmentation results are formed into a directed acyclic graph. By taking the segmentation results as nodes, the edges between words are weighted, and the path with the smallest weight is identified as the final segmentation path, and the text to be processed is segmented through this path, hence at least one word segmentation can be obtained.

S20: performing entity recognition on all the word segmentation results through a preset entity recognition model to obtain at least one entity recognition result.

S30: performing part-of-speech tagging on all the entity recognition results to obtain part-of-speech tagging results.

Understandably, the preset entity recognition model may be obtained by supervised training such as the model based on neural network by using labeled text. The entity recognition result is entity information extracted from the text. Part-of-speech tagging refers to set a part-of-speech tag for entity recognition result according to the preset part-of-speech list.

Specifically, all the word segmentation results are input into the preset entity recognition model, and all the word segmentation results are entity-recognized by the preset entity recognition model. That is, important entity information, such as time, place, person, etc., is extracted from a given text according to the context characteristics, the relationship between sentences and words. Time may be a time entity, place may be a location entity, and person may be name entity, etc., hence at least one entity recognition result can be obtained. Further, the step of performing part-of-speech tagging on all the entity recognition results refers to: according to the preset part-of-speech list, the word or phrase corresponding to each entity recognition result is tagged with part of speech, such as adjectives, verbs, nouns, etc., so that the entity recognition result can be integrated with more useful information in the later processing, hence the part-of-speech tagging result corresponding to each entity recognition result can be obtained.

S40: scoring all the part-of-speech tagging results through a preset scoring metric to obtain score values.

Specifically, after the part-of-speech tagging results are obtained, a preset scoring metric is acquired from database, and all the part-of-speech tagging results are scored by the preset scoring metric. For example, the closer the position of the noun is to the front of the sentence content, the higher the score is, and the higher the frequency of the noun in the paragraph or sentence, the higher the score is. Thus, according to the score values of all scoring metrics corresponding to the one single part-of-speech tagging result, the score value corresponding to this part-of-speech tagging result can be determined. In other terms, all the values corresponding to the same part-of-speech tagging result can be directly added to determine the score value, or the average value of the sum of all the values may be taken as the score value. Alternatively, different weights are assigned for different scoring metrics, and the result of multiplying and adding all the values with the weights is determined as the score value.

S50: filtering all the part-of-speech tagging results based on all the score values to obtain at least one target word.

Specifically, after obtaining the score value, all the score values are compared to obtain a comparison result, and a preset number of part-of-speech tagging results (such as 10 or 20, etc.) with higher score values are selected based on the comparison result. In another embodiment, a preset score threshold is obtained, all score values are compared with the preset score threshold, and when the score value is greater than or equal to the preset score threshold, the part-of-speech tagging result corresponding to the score value would be filtered out. Then, a preset filtering rule and stop word list are obtained, and the preset number of part-of-speech tagging results are filtered out, hence at least one target word is obtained.

S60: running word co-occurrence statistics on all the target words to obtain word co-occurrence values, and performing keyword extraction on all the target words based on the word co-occurrence values to obtain keyword extraction results.

Understandably, the word co-occurrence value is the frequency or probability that two target words appear at the same time. The threshold of keyword extraction based on the word co-occurrence value is different in different cases. For example, the preset threshold is 6 in legal application scenario and 8 in medical application scenario.

Specifically, after the target words are obtained, two different target words may be randomly selected from all the target words to be combined to obtain at least one group of word pairs. Alternatively, based on the part-of-speech tagging results, all the target words are combined according to a preset part-of-speech combination rules, so as to obtain at least one group of word pairs. Then, running word co-occurrence statistics on the word pairs composed of all the target words. That is, the probability or frequency of two target words appearing together in the same sentence in the text to be processed is counted, so that the word co-occurrence value corresponding to each word pair can be obtained. Further, performing keyword extraction on all the target words based on the word co-occurrence values. That is, the preset threshold corresponding to the preset scenario is obtained, all the word co-occurrence values are compared with the preset threshold, if the word co-occurrence value is greater than or equal to the preset threshold, the word pair is characterized as a keyword, and the target word corresponding to the word pair would be extracted. In this way, the keyword extraction results can be obtained by extracting all keywords. In another embodiment, the word co-occurrence values are sorted from smallest to largest, and the lower quartile, upper quartile and interquartile range of a box plot are determined according to the sorting results. Then, the maximum value of interval is determined by the upper quartile and interquartile range. If the word co-occurrence value a is greater than or equal to the maximum value of interval, the word pair corresponding to the word co-occurrence value is determined as a keyword, and the target word corresponding to the word pair would be extracted. In this way, the keyword extraction results can be obtained by extracting all keywords.

In the embodiment of the application, and all the word segmentation results corresponding to the text to be processed are entity-recognized by the preset entity recognition model, so that the entity recognition of the word segmentation result is realized separately, and the acquisition of the entity recognition result is further realized. By performing part-of-speech tagging on and scoring all the entity recognition results, the determination of the tagging results and the acquisition of the score values are realized. By filtering all the part-of-speech tagging results based on all the score values, the noise words are filtered out, and thus the target words are obtained. By running word co-occurrence statistics on all the target words, the computation of word co-occurrence values and the extraction of keywords are realized, and then the extraction of key phrases is realized, which improves the accuracy of keyword extraction.

In an embodiment, in step S20, the preset entity recognition model includes a first entity recognition module and a second entity recognition module. That is, the step of performing entity recognition on all the word segmentation results through a preset entity recognition model to obtain at least one entity recognition result includes:

S201: performing entity recognition on all improper nouns in the word segmentation result by the first entity recognition module to obtain a first recognition result.

Specifically, after the word segmentation results are obtained, all the word segmentation results are input into the preset entity recognition model, and all non-proper nouns in the word segmentation results are entity-recognized by the first entity recognition module of the preset entity recognition model. The word segmentation results may be entity-recognized by using BIO tagging method, BMES tagging method or BIOSE tagging method, where B represents the beginning of entity segment; I represents the middle of entity segment; M represents the middle of entity segment; E represents the end of entity segment; S represents a single word of entity segment; O represents that the character is not any entity. Hence a first recognition result is obtained. When identifying common entities, such as names, places, or time, certain existing disclosed entity recognition models may be used to identify entities, thus reducing costs.

S202: performing entity recognition on all proper nouns in the word segmentation result by the second entity recognition module to obtain a second recognition result.

S203: determining word segmentation results corresponding to the first recognition result and the second recognition result as entity recognition results.

Specifically, performing entity recognition on all proper nouns in the word segmentation result by the second entity recognition module refers to: the module is trained based on a large number of proper noun samples in one single field. When recognizing proper nouns, for example, entities in the legal field, such as “accusation”, “primary and secondary responsibility”, “commutation factor”, “aggravated punishment factor” and “result of sentence”, the accuracy of entity recognition is higher than that of some existing entity recognition models. Hence a second recognition result is obtained. Then, determining all the word segmentation results corresponding to the first recognition result and the second recognition result as entity recognition results. Hence the entity recognition results are obtained. If the non-proper nouns are recognized by the existing disclosed entity recognition model, they are named as First entity recognition model. The entity recognition model corresponding to proper nouns is named Second entity recognition model.

In this embodiment, the entity recognition of word segmentation result is performed by different recognition modules, so that the determination of the first recognition result and the second recognition result is realized, thereby improving the entity recognition accuracy of proper nouns.

In an embodiment, step S30, i. e., performing part-of-speech tagging on all the entity recognition results to obtain part-of-speech tagging results, further includes:

S301: acquiring a preset part-of-speech list, and the preset part-of-speech list comprises at least one target part of speech.

S302: performing part-of-speech tagging on all the entity recognition results based on all the target parts of speech to obtain part-of-speech tagging results.

Understandably, the target parts of speech are noun parts of speech, verb parts of speech and so on in the preset part-of-speech list. It may also be adjectives, quantifiers, pronouns, adverbs, prepositions, conjunctions and so on.

Specifically, a preset part-of-speech list is retrieved from a database, and the preset part-of-speech list includes at least one target part of speech. Then, performing part-of-speech tagging on all the entity recognition results based on all the target parts of speech. That is, the entity recognition results may be labeled with part-of-speech tags in accordance with the contextual characteristics of the entity recognition results, so that the entity recognition results can be integrated with more information, and the part-of-speech tags and the corresponding entity recognition results would be determined as part-of-speech tagging results. Thus the part-of-speech tagging results corresponding to the entity recognition results are obtained. In another embodiment, all the part-of-speech tags of word segmentation results may be labeled, and then filtered through a preset specific part of speech. For example, the part-of-speech tagging results such as nouns, verbs and adjectives are screened out, and the part-of-speech tags and corresponding entity recognition results are determined as part-of-speech tagging results. Thus the part-of-speech tagging results corresponding to the entity recognition results are obtained. In this embodiment, performing part-of-speech tagging on all the entity recognition results based on the preset part-of-speech list, so that each entity recognition result is tagged, and then the determination of the part-of-speech tagging result is realized.

In an embodiment, step S40, i. e., scoring all the part-of-speech tagging results through a preset scoring metric to obtain score values, includes:

S401: acquiring a preset scoring metric set, and the scoring metric set comprises at least one scoring metric.

S402: scoring all the part-of-speech tagging results through all the scoring metrics to obtain metric values.

Specifically, after the part-of-speech tagging result is obtained, a preset scoring metric set is retrieved from database, and the scoring metric set includes at least one scoring metric (which may be set according to the actual situation). Then, all the part-of-speech tagging results are scored based on all scoring metrics. That is, a same part-of-speech tagging result is scored by all scoring metrics. For example, the closer the position of the noun is to the front of the sentence content, the higher the frequency of the noun in the paragraph content or the sentence content, or the more diverse the surrounding words of the noun, the lower the score, so as to obtain the part-of-speech tagging result and the metric value corresponding to each scoring metric. In this way, all the part-of-speech tagging results are scored in turn, and the metric value corresponding to each scoring metric of each part-of-speech tagging result is obtained.

S403: integrating all the metric values corresponding to one single part-of-speech tagging result to obtain a score value.

Specifically, integrating all the metric values corresponding to one single part-of-speech tagging result refers to: all the metric values corresponding to one single part-of-speech tagging result may be directly added and determined as the score value. Alternatively, the average value of the sum of all the metric values may be determined as the score value. Or different weights are assigned for different scoring metrics, and the result of multiplying and adding all the metric values with the weights may be determined as the score value. In this embodiment, the results of part-of-speech tagging are scored based on all the scoring metrics, so that different metrics can score the part-of-speech tagging results, and then the computation of the score value is realized, and the accuracy of subsequent keyword extraction is improved.

In an embodiment, step S50, filtering all the part-of-speech tagging results based on all the score values to obtain at least one target word, further includes:

S501: screening all the part-of-speech tagging results based on all the score values to obtain at least one alternative word.

Specifically, after score values are obtained, all score values are compared, and a preset number of part-of-speech tagging results with larger score values are determined as alternative words. In another embodiment, a preset score threshold is obtained, all score values are compared with the preset score threshold, and when the score value is less than the preset score threshold, the part-of-speech tagging result corresponding to the score value is deleted. When the score value is greater than or equal to the preset score threshold, the part-of-speech tagging result corresponding to the score value is remained, and all the remained part-of-speech tagging results are determined as alternative words, so that at least one alternative word can be screened out from all the part-of-speech tagging results.

S502: filtering all the alternative words based on a preset filtering rule to obtain at least one target word.

Specifically, after alternative words are obtained, a preset filtering rule is obtained, which includes a stop word list and a filtering rule. That is, the stop words would first be removed out of the alternative words according to the stop word list, hence the deletion results are obtained. Then, the alternative words in the deletion result are filtered by filtering rules. For example, the filtering rule may be the length of the word. If the length of the alternative word is less than the length of the word in the filtering rule, it indicates that this alternative word is not the target word, and would be directly filtered out and deleted. Another example, the word with the length of 1 in the alternative words is likely not a keyword and would be directly filtered out. When the length of the alternative word is greater than or equal to the length of the word in the filtering rule, it indicates that the alternative word is the target word, thus at least one target word is screened out from all the alternative words. In this embodiment, all the part-of-speech tagging results are filtered based on all the score values, thus realizing the screening of alternative words. All alternative words are filtered by the preset filtering rule, which realizes the filtering of invalid words and the identification of target words.

In an embodiment, step S60, running word co-occurrence statistics on all the target words to obtain word co-occurrence values, further includes.

S601: running word frequency statistics on all word pairs to obtain a word frequency value corresponding to each word pair respectively; each word pair comprises any of the two target words, and the two target words in each word pair are not exactly the same.

S602: running word co-occurrence statistics on all the word pairs to obtain a co-occurrence value corresponding to each word pair respectively.

S603: determining the word co-occurrence value corresponding to the word pair based on the word frequency value and the co-occurrence value corresponding to one single word pair.

Understandably, the word frequency value is the number of times the word pair appears, or the word frequency value is TF-IDF. The co-occurrence value is the probability that two target words in a word pair appear in a sentence.

Specifically, after the target words are obtained, any two target words in all target words would be combined, and the two target words in each word pair are not exactly the same. Alternatively, all target words are combined according to the part of speech based on the part-of-speech tagging result, thus at least one word pair is obtained. Then, running word frequency statistics on all word pairs refers to: the frequency or TF-IDF of word pairs in the text to be processed is computed, thus the word frequency value corresponding to each word pair is obtained. Further, running word co-occurrence statistics on all the word pairs refers to: the number of times that two target words appear together is counted, i.e., the co-occurrence value of word pairs is equal to the appearing frequency of word pairs divided by the appearing frequency of the last two target words in the same sentence, thus the co-occurrence value corresponding to each word pair is obtained. Finally, determining the word co-occurrence value corresponding to the word pair based on the word frequency value and the co-occurrence value corresponding to one single word pair refers to: multiply the word frequency value corresponding to the same word pair with the co-occurrence value, i.e., the word co-occurrence value is equal to the word frequency value multiplied by the co-occurrence value, thus the word co-occurrence value corresponding to each word pair is obtained. In this embodiment, by running word frequency statistics on all word pairs, the computation of word frequency value corresponding to word pairs is realized. By running word co-occurrence statistics on all the word pairs, the computation of the co-occurrence value is realized, thus the determination of word co-occurrence value is realized.

In an embodiment, before step S20, performing entity recognition on all the word segmentation results through a preset entity recognition model, the method further includes:

S701: acquiring a sample training data set, the sample training data set comprises at least one sample training data, at least one proper noun sample, a first sample label corresponding to each sample training data and a second sample label corresponding to each proper noun sample.

Understandably, proper noun samples are terms in particular fields, such as medical field or testing field. Sample training data may be various text information. A sample training data is associated with a first sample label, and a proper noun sample is associated with a second sample label. The first sample label is used to characterize the real entity recognition result corresponding to the sample training data, and the second sample label is used to characterize the real entity recognition result corresponding to the proper noun sample. The first sample label and second sample label may be obtained by labeling the sample training data and proper noun sample manually or in other ways. It may be collected from different databases, or it may be pre-prepared data sent from the client to the database. Then, a sample training data set is constructed according to all the obtained sample training data, all proper noun samples, all the second sample labels and all the first sample labels.

S702: acquiring a preset training model, and performing entity recognition on all the sample training data through a first entity recognition module of the preset training model to obtain a first recognition label.

S703: performing entity recognition on all the proper noun samples through a second entity recognition module of the preset training model to obtain a second recognition label.

Understandably, the recognition label is obtained by performing entity-recognition on sample data by the preset training model.

Specifically, the preset training model is retrieved from database, all sample training data and all proper noun samples are input into the preset training model, and all sample training data are entity-recognized by the first entity recognition module. That is, the common entities in the sample training data are identified, such as time, place, person, etc. Time may be time entity, place may be location entity, and person may be name entity, etc., thus a first recognition label is obtained. Further, all proper noun samples are identified by the second entity recognition module. That is, the entities in the proper noun samples are identified, for example, proper nouns such as “traffic accident crime” and “traffic accident” in legal documents in the legal field, and multiple entities such as “accident type”, “primary and secondary responsibility” and “result of sentence”, thus a second recognition label corresponding to each proper noun sample is obtained.

S704: determining a predicted loss value of the preset training model according to the first sample label, the second sample label, the first recognition label and the second recognition label.

Understandably, the predicted loss value is generated in the process of predicting the sample training data.

Specifically, after the prediction tags are obtained, all the first recognition labels are arranged according to the order of the sample training data in the sample training data set, and then the first recognition label associated with the sample training data is compared with the first sample label of the sample training data with the same sequence, and the loss value between the first sample label and the first recognition label is determined through loss function. Similarly, all the second recognition labels are arranged according to the order of proper noun samples in the sample training data set, and then the second recognition label associated with proper noun sample is compared with the second sample label of the proper noun sample with the same sequence, and the loss value between the second sample label and the second recognition label is determined through loss function. Until all the sample labels are compared with the recognition labels, the loss values of the two entity recognition modules are directly added, or multiplied by different weights and then added, thus a predicted loss value of the preset training model is obtained.

S705: when the predicted loss value meets a preset convergence condition, recording the converged preset training model as a preset entity recognition model.

Understandably, the preset convergence condition may be the condition that the predicted loss value is less than the preset threshold, and it may also be the condition that the predicted loss value is very small after the 500th time of computation and will not drop again.

Specifically, after the predicted loss value is obtained, when the predicted loss value does not reach the preset convergence condition, an initial parameter of the preset training model is adjusted based on the predicted loss value, and all sample training data and all proper noun samples are re-input into the preset training model for adjusting the initial parameter. And iterative training is performed on the preset training model whose initial parameter has been adjusted, thus the predicted loss value corresponding to the preset training model is obtained. Further, when the predicted loss value does not reach the preset convergence condition, the initial parameter of the preset training model is adjusted again based on the predicted loss value, so that the predicted loss value of the preset training model whose initial parameter has been adjusted again would meet the preset convergence condition. In this way, the recognition result would be approaching the correct result continuously until the predicted loss value of the preset training model reaches the preset convergence condition, and the converged preset training model would be determined as a preset entity recognition model.

In this embodiment, the preset training model is iteratively trained by a large number of sample training data, and the overall loss value of the preset training model is calculated through loss function, thus realizing the determination of the predicted loss value of the preset training model. According to the predicted loss value, the initial parameter of the preset training model is adjusted until the model converges, which realizes the training of the preset entity recognition model, and further ensures the high accuracy of the preset entity recognition model.

It should be understood that the sequence number of each step in the following embodiment does not imply the order of execution, and the order of execution of each process should be determined according to the function and internal logic, and shall not constitute any limitation on the implementation process of the embodiment of the present invention.

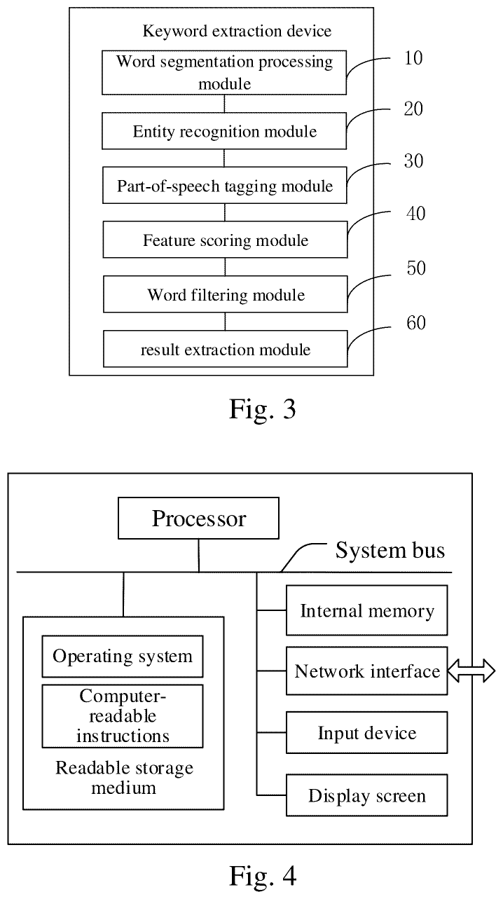

In an embodiment, a keyword extraction device is provided, which corresponds to the keyword extraction method in the above embodiments one by one. As shown in FIG. 3, the keyword extraction device includes a word segmentation processing module 10, an entity recognition module 20, a part-of-speech tagging module 30, a feature scoring module 40, a word filtering module 50 and a result extraction module 60. The detailed explanation of each functional module is as follows:
a word segmentation processing module 10, configured to acquire a text to be processed, and performing word segmentation on the text to be processed to obtain at least one word segmentation result;
an entity recognition module 20, configured to perform entity recognition on all the word segmentation results through a preset entity recognition model to obtain at least one entity recognition result;
a part-of-speech tagging module 30, configured to perform part-of-speech tagging on all the entity recognition results to obtain part-of-speech tagging results;
a feature scoring module 40, configured to score all the part-of-speech tagging results through a preset scoring metric to obtain score values;
a word filtering module 50, configured to filter all the part-of-speech tagging results based on all the score values to obtain at least one target word; and
a result extraction module 60, configured to run word co-occurrence statistics on all the target words to obtain word co-occurrence values, and perform keyword extraction on all the target words based on the word co-occurrence values to obtain keyword extraction results.

In one embodiment, a computer equipment is provided, which may be a terminal, and its internal structure diagram may be as shown in FIG. 4. The computer equipment includes a processor, a memory, a network interface, a display screen and an input device connected through a system bus. The processor of the computer equipment is used for providing computing and control capabilities. The memory of the computer equipment includes a readable storage medium and an internal memory. The nonvolatile storage medium stores an operating system and computer-readable instructions. The internal memory provides an environment for the operation of the operating system and computer-readable instructions in the readable storage medium. The network interface of the computer equipment is used to communicate with external servers through network connection. The computer-readable instructions, when executed by a processor, implement the keyword extraction method. The readable storage medium provided by this embodiment includes a nonvolatile readable storage medium and a volatile readable storage medium.

In one embodiment, a computer equipment is provided, which includes a memory, a processor and computer-readable instructions stored in the memory and executable on the processor, and the processor implements the keyword extraction method when executing the computer-readable instructions.

In one embodiment, one or more computer-readable storage media storing computer-readable instructions are provided, and the readable storage media provided in this embodiment include non-volatile readable storage media and volatile readable storage media. The readable storage medium has stored thereon computer-readable instructions which, when executed by one or more processors, realize the above keyword extraction method.

A person of ordinary skill in the art can understand that all or part of the processes in the method of the foregoing embodiments can be implemented by instructing related hardware through computer readable instructions, which can be stored in a nonvolatile computer readable storage medium, and the computer readable instructions can include the steps of the above embodiments. Wherein, any reference to memory, storage, database or other medium used in the embodiments provided in this application may include nonvolatile and/or volatile memory. The nonvolatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus, (Rambus) direct RAM (RDRAM), direct memory bus dynamic RAM (DRDRAM), and memory bus dynamic RAM (RDRAM), etc.

A person of ordinary skill in the art can clearly understand that, for the convenience and conciseness of description, the division of the above functional units and modules are only used as examples. In practical applications, the above functions may be implemented by different functional units and modules as needed. That is, the internal structure of the device may divided into different functional units or modules to complete all or part of the functions described above.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and shall be included in the protection scope of this application.

What is claimed is:

1. A keyword extraction method, comprising:
acquiring a text to be processed, and performing word segmentation on the text to be processed to obtain at least one word segmentation result;
performing entity recognition on all the word segmentation results through a preset entity recognition model to obtain at least one entity recognition result;
performing part-of-speech tagging on all the entity recognition results to obtain part-of-speech tagging results;
scoring all the part-of-speech tagging results through a preset scoring metric to obtain score values;
filtering all the part-of-speech tagging results based on all the score values to obtain at least one target word; and
running word co-occurrence statistics on all the target words to obtain word co-occurrence values, and performing keyword extraction on all the target words based on the word co-occurrence values to obtain keyword extraction results.

2. The keyword extraction method of claim 1, wherein the preset entity recognition model comprises a first entity recognition module and a second entity recognition module;
the step of performing entity recognition on all the word segmentation results through a preset entity recognition model to obtain at least one entity recognition result comprises:
performing entity recognition on all improper nouns in the word segmentation result by the first entity recognition module to obtain a first recognition result;
performing entity recognition on all proper nouns in the word segmentation result by the second entity recognition module to obtain a second recognition result; and
determining word segmentation results corresponding to the first recognition result and the second recognition result as entity recognition results.

3. The keyword extraction method of claim 1, wherein the step of performing part-of-speech tagging on all the entity recognition results to obtain part-of-speech tagging results comprises:
acquiring a preset part-of-speech list, wherein the preset part-of-speech list comprises at least one target part of speech; and
performing part-of-speech tagging on all the entity recognition results based on all the target parts of speech to obtain part-of-speech tagging results.

4. The keyword extraction method of claim 1, wherein the step of scoring all the part-of-speech tagging results through a preset scoring metric to obtain score values comprises:
acquiring a preset scoring metric set, wherein the scoring metric set comprises at least one scoring metric;
scoring all the part-of-speech tagging results through all the scoring metrics to obtain metric values; and
integrating all the metric values corresponding to one single part-of-speech tagging result to obtain a score value.

5. The keyword extraction method of claim 1, wherein the step of filtering all the part-of-speech tagging results based on all the score values to obtain at least one target word comprises:
screening all the part-of-speech tagging results based on all the score values to obtain at least one alternative word; and
filtering all the alternative words based on a preset filtering rule to obtain at least one target word.

6. The keyword extraction method of claim 1, wherein the step of running word co-occurrence statistics on all the target words to obtain word co-occurrence values comprises:
running word frequency statistics on all word pairs to obtain a word frequency value corresponding to each word pair respectively; each word pair comprises any of the two target words, and the two target words in each word pair are not exactly the same;
running word co-occurrence statistics on all the word pairs to obtain a co-occurrence value corresponding to each word pair respectively; and
determining the word co-occurrence value corresponding to the word pair based on the word frequency value and the co-occurrence value corresponding to one single word pair.

7. The keyword extraction method of claim 1, wherein before performing entity recognition on all the word segmentation results through a preset entity recognition model, the method further comprises:
acquiring a sample training data set, the sample training data set comprises at least one sample training data, at least one proper noun sample, a first sample label corresponding to each sample training data and a second sample label corresponding to each proper noun sample;
acquiring a preset training model, and performing entity recognition on all the sample training data through a first entity recognition module of the preset training model to obtain a first recognition label;
performing entity recognition on all the proper noun samples through a second entity recognition module of the preset training model to obtain a second recognition label;
determining a predicted loss value of the preset training model according to the first sample label, the second sample label, the first recognition label and the second recognition label; and
when the predicted loss value meets a preset convergence condition, recording the converged preset training model as a preset entity recognition model.

8. A keyword extraction device, comprising:
a word segmentation processing module, configured to acquire a text to be processed, and performing word segmentation on the text to be processed to obtain at least one word segmentation result;
an entity recognition module, configured to perform entity recognition on all the word segmentation results through a preset entity recognition model to obtain at least one entity recognition result;
a part-of-speech tagging module, configured to perform part-of-speech tagging on all the entity recognition results to obtain part-of-speech tagging results;
a feature scoring module, configured to score all the part-of-speech tagging results through a preset scoring metric to obtain score values;
a word filtering module, configured to filter all the part-of-speech tagging results based on all the score values to obtain at least one target word; and
a result extraction module, configured to run word co-occurrence statistics on all the target words to obtain word co-occurrence values, and perform keyword extraction on all the target words based on the word co-occurrence values to obtain keyword extraction results.

9. A computer equipment, comprising a memory, a processor and computer-readable instructions stored in the memory and executable by the processor, wherein when the processor executes the computer-readable instructions, the keyword extraction method of claim 1 is realized.

10. One or more readable storage media, storing computer-readable instructions, wherein when the computer-readable instructions are executed by one or more processors, the keyword extraction method of claim 1 is implemented.
